(19) United States
(12) Patent Application Publication
(10) Pub. No.: US 2008/0208565 A1
(43) Pub. Date: Aug. 28, 2008

(54) Method for Automatic Translation From a First Language to a Second Language and/or for Processing Functions in Integrated-Circuit Processing Units, and Apparatus for Performing the Method

(76) Inventor: Orlando Bisegna, Capistrello (IT)

Correspondence Address: Modiano & Associati, Via Meravigli, 16, Milano, 20123, omitted

(21) Appl. No.: 11/660,598

(22) PCT Filed: Aug. 25, 2005
(86) PCT No.: PCT/EP2005/009187

§ 371 Date: Feb. 20, 2007

(30) Foreign Application Priority Data
Aug. 31, 2004 (IT) PD2004A000222
Nov. 5, 2004 (IT) PD2004A000274

(51) Int. Cl. G06F 17/28

(52) U.S. Cl. 704/4

(57) ABSTRACT

A method for automatic translation from a first language to a second language, according to the invention, comprising the steps of:
a) acquiring an initial sentence or text to be translated;
b) selecting one or more automatic translation techniques;
c) generating a plurality of translations of the initial sentence or text from the first language to the second language by means of the selected translation technique or techniques;
d) for each one of the translations into the second language, generating a back-translation from the second language to the first language;
e) comparing said back-translations into the first language with the initial sentence or text in the first language and generating a corresponding index of deviation;
f) selecting, among the translations into the second language, the translation that corresponds to the back-translation for which the index of deviation is lowest or nil.

### TECHNICAL FIELD

The present invention relates to a method for automatic translation from a first language to a second language and to an apparatus for performing said automatic translation.

The present invention also relates to a method for integrated-circuit processing units and to an apparatus for performing said processing.

### BACKGROUND ART

As it is known, “automatic translation” is the name given to methods that automate partially or totally the process of translation from one language to another.

Research into automatic translation began with the birth of advanced electronic devices.

There have been disputes regarding who started this research first.

Although conversations and correspondence between the British crystallographer Andrew Booth and Warren Weaver, a director of the Rockefeller foundation, bear witness to the initial development of the rough concepts of automatic translation, it was Weaver who in 1949 made public the concept of using computers for translation.

Intense research was carried out in the specific field, both in Europe and in the United States, in the 1950s.

The first conference on the subject was held in 1952 and an automatic translation system was shown in 1954.

In 1959, IBM installed a system for the United States Air Force, and Georgetown University installed others at the United States Atomic Energy Agency.

The poor results induced the United States National Science Academy to found, in 1966, the ALPAC, which had the task of assessing the effectiveness, costs and potential progress of automatic translation.

The assessments of the ALPAC report were negative, recommending against further funding of the research project and indicating that only the development of assisted translation was possible.

From that moment onward, the possibility to provide a method and an apparatus capable of performing fully automatic translation seemed to have faded.

In 1976, Canada made public its weather system, which translated weather forecasts, and then Systran, a Russian-English translation system, was devised in Europe.

All the devised methods failed to yield appreciable results, since the translations obtained were not acceptable.

The main problems encountered in automatic translation are:
ambiguity;
structural differences between languages;
units constituted by more than one word, which assume particular meanings in the various languages, such as collocations and idioms.

Everything would be easier if sentences and words had a single interpretable meaning, but all languages have ambiguities on various levels:
when a word can assume a plurality of meanings, it is classified as lexically ambiguous;
when a sentence can be interpreted in a plurality of ways, it is termed structurally ambiguous.

The fundamental problem of ambiguity is the selection of the correct semantic interpretation.

The structural and lexical differences among languages often consist of the different order of the words within the sentence.

For example, considering a same sentence in two different languages, one might have:

(language A) subject-verb-object.

(language B) verb-subject-object.

In addition to this, there are other translation problems:
the presence or absence of articles within the sentence;
the existence of lexical gaps: the destination language must express the meaning of a word of the source language by means of a phrase due to the absence of the corresponding term;
the generation of tenses.

In addition, as it is known, the processing unit is the core of the entire processing system, since it controls and coordinates the operation of all the other elements that compose the processing system.

Merely by way of illustration and clarification of this complex subject, a limited example of processing unit, termed control unit, contained within computer microprocessors (CPU—central processing unit), is analyzed.

In particular, the control unit is designed to decode and interpret the instructions, generating the signals for activating all the execution components contained within the computer.

The control unit of current systems has the structure of a computer which is assigned, in each instance, the task of executing the microprogram associated with the instruction to be executed.

In the microprogrammed control unit, one can distinguish:
a control memory, which contains all the microprograms;
a microprogram counter;
a current microinstruction register.

The operations required to perform an instruction are summarized as follows:
the operating code contained in the instruction register is sent to an instruction decoder, which generates a microprogram address;
this address is loaded into the microprogram counter and points, within the control memory, to the first microinstruction of the program associated with the instruction to be executed;
the microinstructions of this microprogram are executed sequentially, and at each step the corresponding signals enable the respective functional units, while the address of the next microinstruction is carried into the microprogram counter.

The control units are implemented on thin silicon wafers, known as integrated circuits or chips. Each integrated circuit contains millions of extremely small switches (transistors), which are mutually connected by narrow aluminum tracks. The transistors and the connecting filaments form these data processing circuits.

The integrated circuits are constituted by interconnected electronic components: resistors, capacitors, inductors, sensors, transducers, batteries, generators and vacuum tubes.

Current computer microprocessors reveal a series of functional limitations in addition to problems of stability in processes.

On the basis of current manufacturing logic, even the most sophisticated computer microchip in fact often faces enormous problems as regards the development and calculation of very complex mathematical expressions, therefore causing problems of instability of the system in addition to the subsequent and inevitable slowing of processes.

Accordingly, all the peripherals connected to the central CPU are subject to malfunctions or errors of various kinds.

A valid example is the typical “stalled state” that affects the processor when a large quantity of data present on the central unit cannot be processed, thus causing a complete halt of the entire system. This problem, in highly professional systems (e.g., systems for controlling traffic management, hospital machines, etc), can cause huge damage.

All this is accompanied by the fact that despite considerable developments, modern computer microprocessor logics have remained almost completely unchanged with respect to the main model of computer microprocessor.

The limitations and problems of current CPU architectures can also cause corresponding malfunctions in other elements of any computerized system (e.g., a mass storage unit), since an unexpected stop of data processing on the part of the CPU can cause the failure of various components.

Currently, there are huge limitations for processing units for very complex functions, such as for example for robotics, for control systems for spacecraft or aircraft, for supercomputers, for servers, for every medium and complex automation system, for artificial intelligence and for cybernetics.

### DISCLOSURE OF THE INVENTION

The aim of the present invention is to provide a method for obtaining a full automatic translation without any additional intervention for revision or correction on the part of the user.

Within this aim, an object is to provide an apparatus that is capable of performing automatic translation.

A further object is to provide a method and an apparatus that are capable of performing an automatic translation in which the logical meaning of each sentence or text is correct.

Another object is to provide a method that can be performed with a new apparatus obtained from the original combination of known parts and devices.

Another object of the present invention is to provide a method for obtaining a rapid processing of data in integrated circuits, especially in the case of complex processing which currently is not technically possible due to the reasons described above.

Another object is to provide an apparatus that is capable of performing such processing.

A still further object is to provide a method and an apparatus that are capable of performing data processing in integrated circuits in a less bulky and faster manner than current systems and are capable of performing complex processing which cannot be performed by current processing systems.

Another object is to perfect a method that can be provided by means of a new apparatus obtained from the original combination of known parts and microdevices or devices.

The proposed aim and objects, which will become better apparent hereinafter, are achieved by a method for automatic translation from a first language to a second language, which comprises the steps of:
acquiring an initial sentence or text to be translated;
selecting one or more automatic translation techniques;
generating a plurality of translations of said initial sentence or text from the first language to the second language by means of the selected translation technique or techniques;
for each one of said translations into said second language, generating a back-translation from the second language to the first language;
comparing said back-translations into said first language with the initial sentence or text in the first language and generating a corresponding mutual index of deviation;
selecting, among said translations into the second language, the translation that corresponds to the back-translation for which the index of deviation is lowest or nil.

The logic on which the method expressed above is based is used conveniently, according to the present invention, also to solve problems linked to the development and calculation of highly complex mathematical expressions in electronic processing systems.

The proposed aim and objects, which will become better apparent hereinafter, are also achieved by a method for integrated-circuit processing unit, which comprises the steps of:
a) acquiring an input function;
b) selecting at least one preset logic in order to generate instructions;
c) generating a first recognition, i.e., generating at least one instruction of said function by means of at least one selected preset logic;
d) for each one of said obtained instructions, generating a reverse recognition by means of at least one second preset logic;
e) comparing said instructions, reobtained in the reverse recognition, with the input function;
f) selecting, among said instructions obtained during first recognition, the instruction corresponding to the instruction obtained during second recognition which, compared with the input function, generates the smallest index of deviation or a nil index.

### BRIEF DESCRIPTION OF THE DRAWINGS

Further characteristics and advantages of the invention will become better apparent from the description, given by way of non-limiting example, of the methods and apparatuses according to the invention, with the aid of the accompanying drawings, wherein:

FIG. 1 is a logic diagram of translation according to a widespread known technique;

FIG. 2 is an exemplifying diagram of the method and of the corresponding apparatus that performs it according to the new invention;

FIG. 3 is an exemplifying sequential logic diagram of the method and of the apparatus that performs it, according to the new invention;

FIG. 4 is another diagram, given by way of example, the method for full automatic translation with auto-correction, according to the new invention;

FIG. 5 is an example of a logic diagram of how an integrated-circuit processing unit proceeds in the background art;

FIG. 6 is an example of an exemplifying logic diagram of the method and of the corresponding apparatus that performs it according to the new invention;

FIG. 7 is an example of an exemplifying diagram of operation of the procedure for selection of the instruction or microinstruction executed by the processing unit and of the corresponding apparatus that executes it according to the new invention, in which the analysis of the numeric structure in input, in the reverse path, occurs within the register;

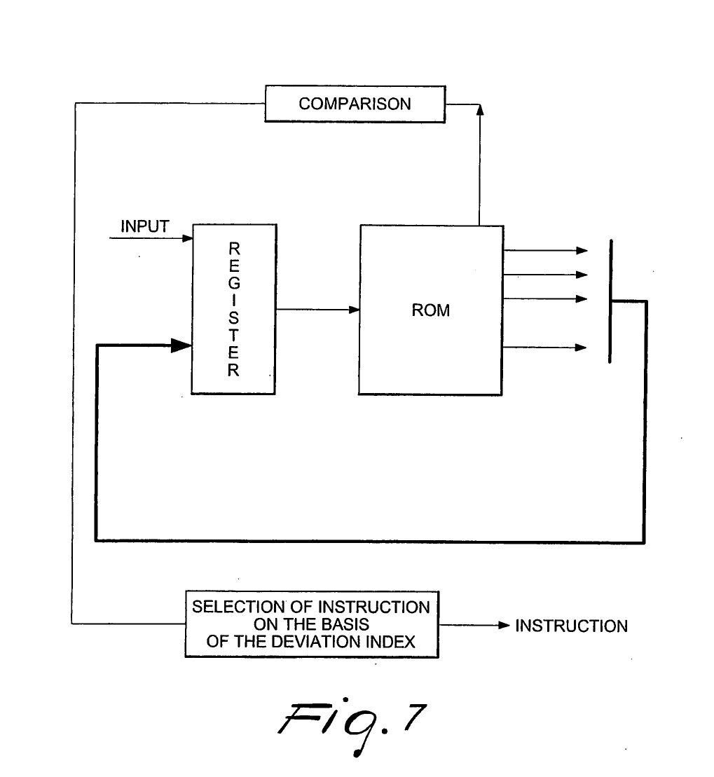

FIG. 8 is an example of an exemplifying diagram of the operation of the procedure for selection of the instruction or microinstruction executed by the processing unit and of the corresponding apparatus that executes it according to the new invention, in which the analysis of the numeric structure in input, in the reverse path, occurs directly in ROM memory;

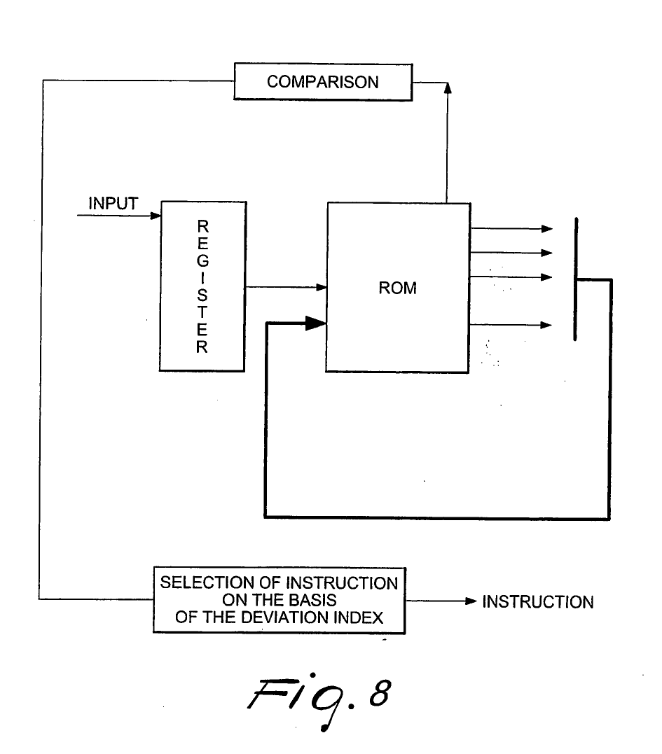

FIG. 9 is an example of an exemplifying sequential logic diagram of the method and of the corresponding apparatus that performs it according to the new invention;

FIG. 10 is another example of an exemplifying diagram of the method and of the corresponding apparatus that performs it according to the new invention;

FIG. 11 is another example of a sequential exemplifying diagram, with clarifications in the comparison step and in the step for final selection of the instruction or microinstruction, of the method and of the corresponding apparatus that performs it, according to the new invention.

### WAYS OF CARRYING OUT THE INVENTION

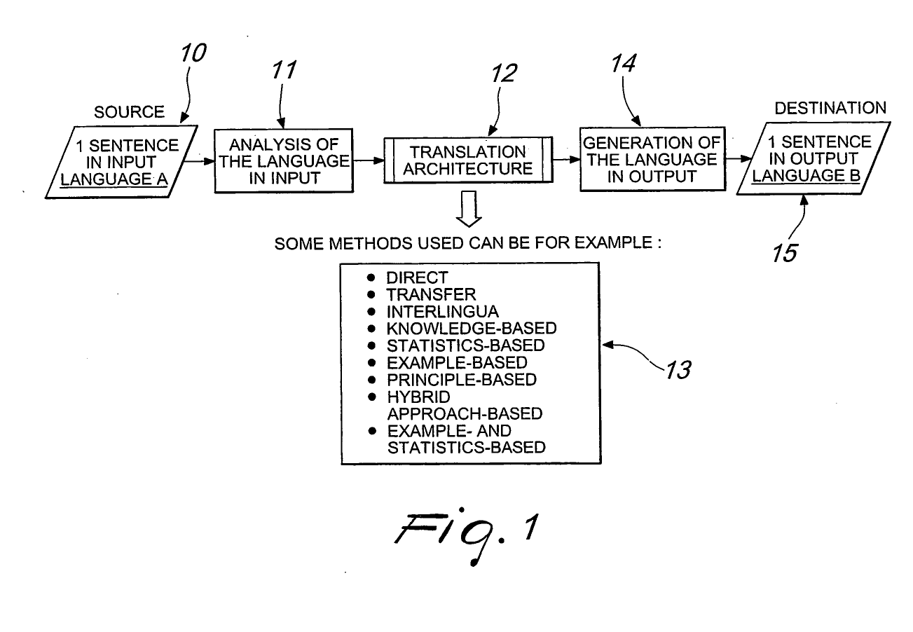

With reference to the figures, FIG. 1 shows how a translation from a language A to a language B is performed in the background art.

The sentence or text is introduced in an input module 10, which can be a writing module.

From this input module 10, the sentence or text is transferred to an analysis module 11.

The sentence or text thus analyzed and processed passes to a translation module 12, which by using a known method, contained in an internal section 13 thereof, performs the translation and sends it to a module for generating the sentence or text in the output language 14.

From this module 14, the sentence or text is sent to an output module 15.

The section 13 normally contains one of the known translation methods or architectures, which can be defined schematically as: direct, transfer, interlingua, knowledge-based, statistics-based, example-based, principle-based, hybrid approach-based, example-based, and example- and statistics-based.

All these translation architectures or methods are known but, as mentioned, each one has severe problems for good translation of the input sentence or text due to the issues already explained.

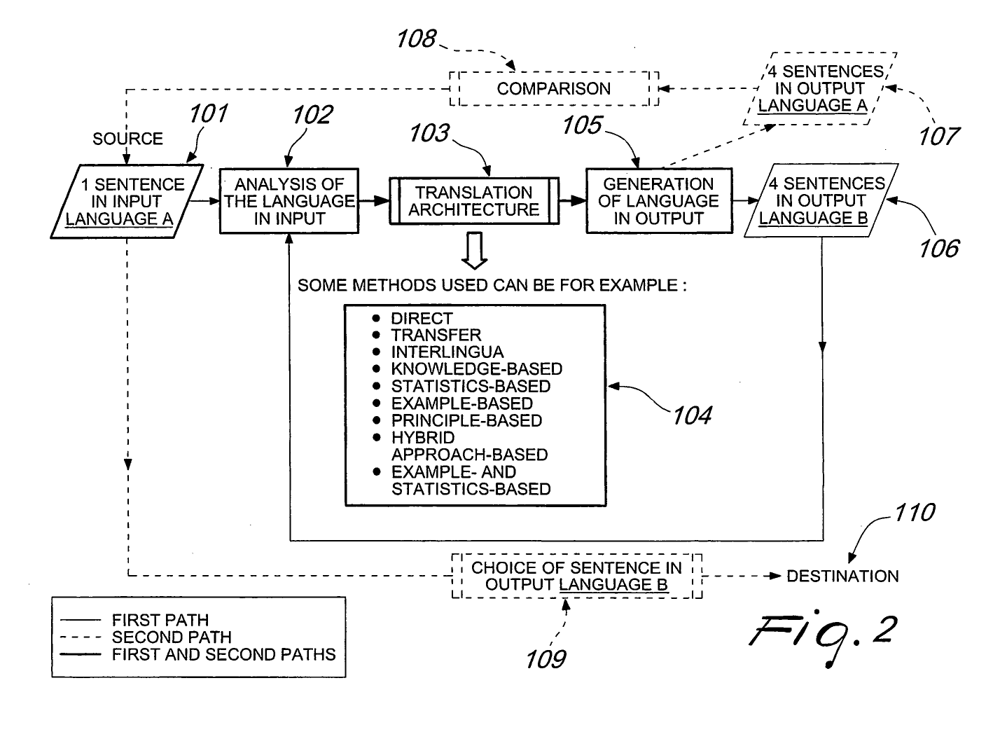

FIG. 2 is an example of a diagram of the new method, which also illustrates schematically the apparatus that performs the translation.

In this case, there is an input module 101, into which the original sentence or text in the language A is input in written form.

The original sentence (or text) in the language A is transferred to an analysis module 102, which transfers it to a translation module 103.

The module contains, preferably in one of its memories, one or more of the translation methods shown in FIG. 1, which are therefore known in the background art or will be available.

The translation module performs, by using one or more of the available methods, a plurality of translations into the output language, i.e., into language B.

By way of example, it is assumed that four separate translations are made from a single input sentence or text, although it is also possible to perform a larger or smaller number of translations, but always more than one.

The translated sentences form within the module 105 for generating sentences in language B in output.

This module 105 transfers the four sentences to the module 106, which is a module for accumulating and/or sending back the sentences translated into language B.

The module 106 returns the four sentences translated into language B to the module 102, which analyzes them again and sends them to the translation module 103, which by using this time preferably just one of the methods contained in the module 104 translates the sentences that were in language B into sentences in language A, which are formed within the module 105.

The module 105 sends the four sentences, which are now in language A, to the module 107, which accumulates them and/or sends them to a module 108, which compares the new four sentences in language A with the original sentence or text in language A of the input module 101.

By means of the comparison, the sentence or text that more closely matches the original sentence or text in language A is chosen with a method described hereinafter and is sent to a module 109, which takes the sentence in language B that corresponds to the sentence in language A in output from the module 107 that is closest to the original sentence in language A and sends it to the destination 110.

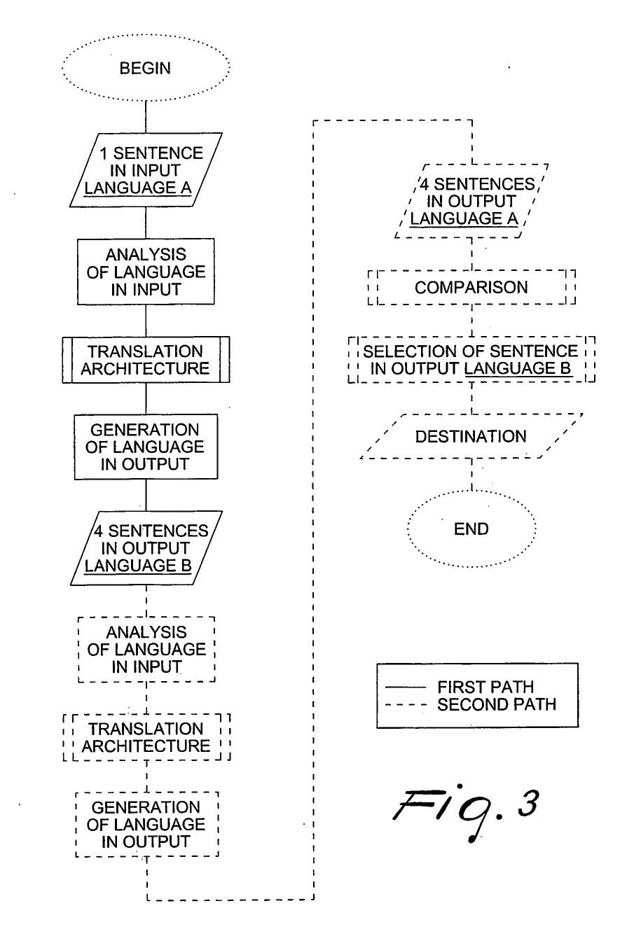

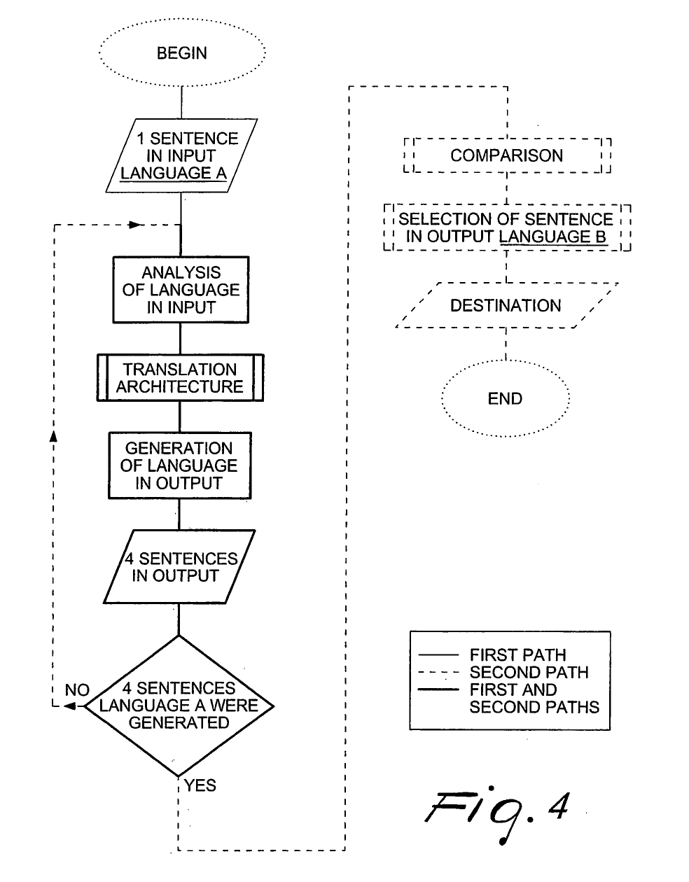

What has been described in FIG. 2 is further illustrated also in the examples of diagrams of FIGS. 3 and 4.

As can be seen, it is fundamental to generate a plurality of translations of the same initial sentence or text with one or more systems, in order to obtain various translation options, and to have at least one second back-translation path.

Analysis of the language in input and generation of the language in output can also be comprised within the same translation architecture in a single module.

The methods used by the translation architecture may be the ones that have been described or other present or future ones, since the method works with any present or future translation architecture.

The system can operate both with total automation and with human intervention in one or more points in order to make it to proceed.

The translation method or methods that are used in the first path can be identical or different with respect to the method or methods used in the second path or in additional paths.

In any case, the method or methods can belong to the same translation architecture or to one or more different translation architectures (sequential diagram of FIG. 3 and superimposed diagram of FIG. 4).

Back-translation can be performed by the same translation architecture used in the first path or by another translation architecture or by other translation architectures that use the same method or other different methods.

The back-translation path can follow the same internal routes (various translation options and/or modes, preferably within the translation module) as the first path (in this way, the differences may optionally be canceled out) or can follow one or more internal routes that are different from the first path and can include one or more, or all, of the routes of the first path inside it, or can be entirely different.

The entire system can of the single-, two- or multiple-language type, both in input and in output and/or internally, and/or it can use as many vocabularies (or memory cards) as needed and/or can be created and/or preset for one, two or more languages.

The user can choose one or more of the sentences obtained with the back-translation, and in this case the choice of the sentence or sentences is made directly by the user by comparing, in his opinion, the sentence or sentences to be chosen and therefore the corresponding translations.

The comparison parameter or parameters can be chosen or selected by the user in each instance or at the beginning of the translation of the sentence or of the entire document or even for each individual comparison that is made (for example, four different selections of parameters can be made for translating each individual sentence).

The system might also give the results of the parameter or parameters to be compared or that have been compared and the user may then make the choice or simply give a start command to obtain the output or outputs.

The final outputs may also be more than one and the user can have the option of choosing the right one or ones purely on his own or by way of a suggestion or indication of the system or by way of the visualization of the parameter or parameters.

Along the first path, it is also possible to arrange for providing a single output or a single sentence or text at a time, until for example one obtains four different sentences, and then perform the back-translation path (or return path or reverse path).

Back-translation can be performed all at once (i.e., for all the sentences in a single instance) or in a plurality of instances and can be performed for all sentences or for one or more sentences.

The comparison also can be performed all at once (i.e., for all the sentences in a single instance) or in a plurality of instances and can be performed for all sentences or for one or more sentences.

It is also possible to have a plurality of systems working simultaneously or at different times which generate one or more sentences and then back-translate them and compare them.

The various outputs at the first path can be obtained with the same identical translation method or with a plurality of different methods, and the same applies for the second path or for any other paths.

The system can be preset on a number of outputs according to the requirements or can have a fixed number of outputs.

The apparatus or system, if working in the voice field, can recognize the length of the sentences or their mutual separation and in a general case, even a non-voice one, by means of the punctuation and/or pauses and/or silences and/or empty spaces and/or changes in the tone of voice (all this can also be performed by the voice application).

The system can be used in various translation applications (fixed telephone, mobile telephone, home computer, portable PC, devices for translating between people, television, cinema, radio, press, magazines, newspapers, or others), both for writing and for voice.

The voice application, if present, can be internal to the system or can be external and applied.

In view of the availability of translation software that has the option of subject selection, it can be convenient to translate the initial sentence or text in the various contexts or subjects and then back-translate the resulting translation or translations in the reverse path by means of the same contexts or by using the general subject or context.

Furthermore, the initial sentence or text might be translated with one or more general contexts, which belong to the same translation system or to a plurality of translation systems with the same method or with different methods, and the resulting translation or translations might be back-translated with a plurality of contexts or with a single context of a single system or of a plurality of architecture systems.

The sentences produced by the translation architecture along the first path must have mutual differences and may be similar but not perfectly identical; this rule can be applied, for each translation, to all the sentences or to one or more of them.

After performing back-translation and after identifying the sentence or text or sentences (which belong to the same language as the source text) that have yielded the best comparison results, the system is capable of identifying the sentence or text or sentences (which is/are in a language that is different from the language of the source text and was/were obtained during the first path) from which the sentences or sentence or text that yielded the best comparison results were translated, and of sending it/them to the destination.

It is possible to perform a plurality of paths and/or a plurality of path loops.

The return path can have a plurality of outputs or a single output for each sentence or text in input along on the same path.

Since a plurality of outputs can occur in the first path, the translation architecture can have a richer vocabulary (with multiple options also for the meaning of the individual words), in view of the possibility to obtain a plurality meanings.

The system along the return path can analyze the sentences even better because it may have already identified the subject.

1. Comparison Parameters

The parameters that are used can be one or more or all of the following:
the parameters and/or methods used to compare words, or a sentence or sentences, or a period or periods, or a text or texts in the step for comparison with the initial sentence or text or source or original text or starting text, all of which belong to the same language, can be:

| | | |
|---|---|---|
| Semantic analysis | | |
| Syntactic analysis | | Analysis and |
| Morphological analysis | {close oversize brace} | comparison of |
| Interlingua | | the two sentences |
| General analysis | | |

Parameters that can be Used

Comparison Between the Two Sentences of:
subjects;
verbal predicates;
verb tenses;
objects;
resulting identical words and/or terms;
resulting identical words and/or terms that maintain the same identical position in the two sentences.

These parameters and/or methods can be used in all the comparisons between the obtained back-translated sentences and the initial one and thus select the best result, or reject the worst results and consequently leave the best.

The comparison can occur for the various sentences at the very same time or at different times.

The comparison can also be performed periodically, after accumulating sentences or texts which may even be completely different from one another, automatically or by means of a manual command.

The comparison between the two sentences can yield results of two types:
the two sentences are perfectly identical;
if they are not perfectly identical, the best obtained results or results, i.e., the sentence or sentences that more closely approximate the initial sentence or text, is/are chosen directly or indirectly or by exclusion.

A single sentence or a plurality of sentences can be chosen from the comparison.

The comparison can be repeated a plurality of times on the same sentences at the same time or at different times and on sentences that have already been compared or not, i.e., in a mixed system, at the same time and at different times.

In the terminology used:
“source” is equivalent to “original text” or “starting text”,
“word” or “words”, or “sentence” or “sentences”, or “period” or “periods”, or “text” or “texts” in both languages A or B, are equivalents;
“analysis” or “study” of language A are equivalents;
“generation” or “synthesis” or “development” of language B are equivalents;
“destination” or “target” or “translation” or “final text” are equivalents;
“word” or “words”, or “sentence” or “sentences”, or period or periods”, or “text” or “texts” in output or in input are equivalents.

Examples are given by way of indication.

### EXAMPLE 1

source in language A:
read this and you will probably run to the chemist's into a panic to stock your medicine cabinets with the latest patent cures.

Four sentences in output, language B:
1) Leggete che probabilmente questo e voi correrete dal chimico in panico per immagazzinare il vostro armadio di medicina con le ultime cure brevettate.
2) Legga questo e lei probabilmente correrà il chimico dal panico per approvvigionare il suo armadietto di medicina con le ultime cure patenti.
3) Leggete questo e probabilmente correrete in farmacia presi dal panico per riempire l'armadietto dei medicinali con le ultime specialità farmaceutiche.
4) Legga questo e lei correrà probabilmente ii chimico in panico approvvigionare il suo armadietto delta medicina con le cure patenti e ultime.

Four sentences in output, language A (back-translated sentences):
1) You read that this and you will probably run to the chemist in panic to store your medicine wardrobe with the last patented cares.
2) Read this and she will probably run the chemist from the panic to provision his locker with medicine with the last suffering cares.
3) Read this and you will probably run to the chemist's into a panic to stock your medicine cabinet with the last patent cures.
4) Read this and her provisioning his locker in panic with the medicine with the suffering cares will probably run the chemist and last.

### Comparison:

| | | |
|---|---|---|
| | | Sentence no. 1 = 16 |
| Identical | | Sentence no. 2 = 13 |
| words | {open oversize brace} | Sentence no. 3 = 23 |
| | | Sentence no. 4 = 12 |

Choice of sentence in output, language B:

The best result was obtained by sentence number 3, with 23 exact terms out of a total of 24.

Therefore, the corresponding sentence in Language B is sent to the destination.

Destination:
Leggete questo e probabilmente correrete in farmacia presi dal panico per riempire l'armadietto dei medicinali con le ultime specialità farmaceutiche.

### EXAMPLE 2

Source in language A:

I would be obliged if you would advise me of the planned delivery date in advance.

Four sentences in output, language B:
1) Io si obbligherebbe se lei potesse mettermi al corrente della data di consegna progettata in anticipo.
2) Le sarei riconoscente di comunicarmi in anticipo la data prevista per la consegna.
3) Si obbligherebbe se lei potesse consigliarmi della data della consegna progettata in anticipo.
4) Sarei costretto se poteste informarmi sulla data di consegna programmata in anticipo.

Four sentences in output, language A (back-translated sentences):
1) I would force himself if she could put me to the current one of the deliver planned date in advance.
2) I would be obliged if you would inform me of the planned delivery date in advance.
3) One would force if she could recommend me of the delivery date planned in advance.
4) I would be forced if you could inform me about the delivery date planned in advance.

Comparison:

| | | |
|---|---|---|
| | | Sentence no. 1 = 11 |
| Identical | | Sentence no. 2 = 15 |
| words | {open oversize brace} | Sentence no. 3 = 10 |
| | | Sentence no. 4 = 12 |

Choice of sentence in output, language B:

The best result was achieved by sentence number 2, with 15 correct terms out of a total of 16.

Therefore, the corresponding sentence in Language B is sent to the destination:
Le sarei riconoscente di comunicarmi in anticipo la data prevista per la consegna.

The advantages of the new system with respect to current ones and with respect to systems currently being developed are:
Full automatic translation with auto-correction, without any intervention for human revision or correction, since the system is in fact capable of self-correcting automatically.
Accordingly, in practice, the correct translation of the logical meaning is obtained.
The logical meaning retains its initial characteristics, since it is not extrapolated and reproduced but is obtained as a consequence of translation.
The system is preset for any combination of languages, without any variation of its logic scheme.
The system is preset for any type of translation method or architecture, both current and under development, including the interlingua method. This aspect is extremely important from a technical standpoint and also from a commercial standpoint.
The system does not require particular technical processing or complex physical structures.
Production and management costs are within the same range as the current inefficient systems for automatic translation and are also lower with respect to interlingua.

By applying the same logic, it is possible to provide a method for a processing unit with integrated circuits, as stated earlier.

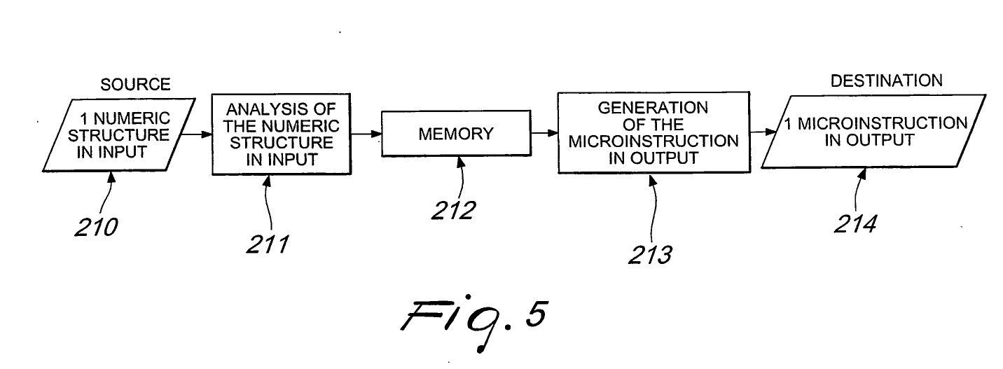

FIG. 5 is an example of a logic diagram of how, in the background art, an integrated-circuit processing unit proceeds schematically:
the numeric structure is input into an input module 200;
from this input module 200, the numeric structure is transferred to an analysis module 211, where it is analyzed and decoded in order to be interpreted by the memory;
the numeric structure thus analyzed passes into a memory module 212, which by using a preset logic chooses the instruction or microinstruction and sends it to a module 213 for generating the instruction or microinstruction;
from this generation module 213, the instruction or microinstruction is transferred into an output module 214.

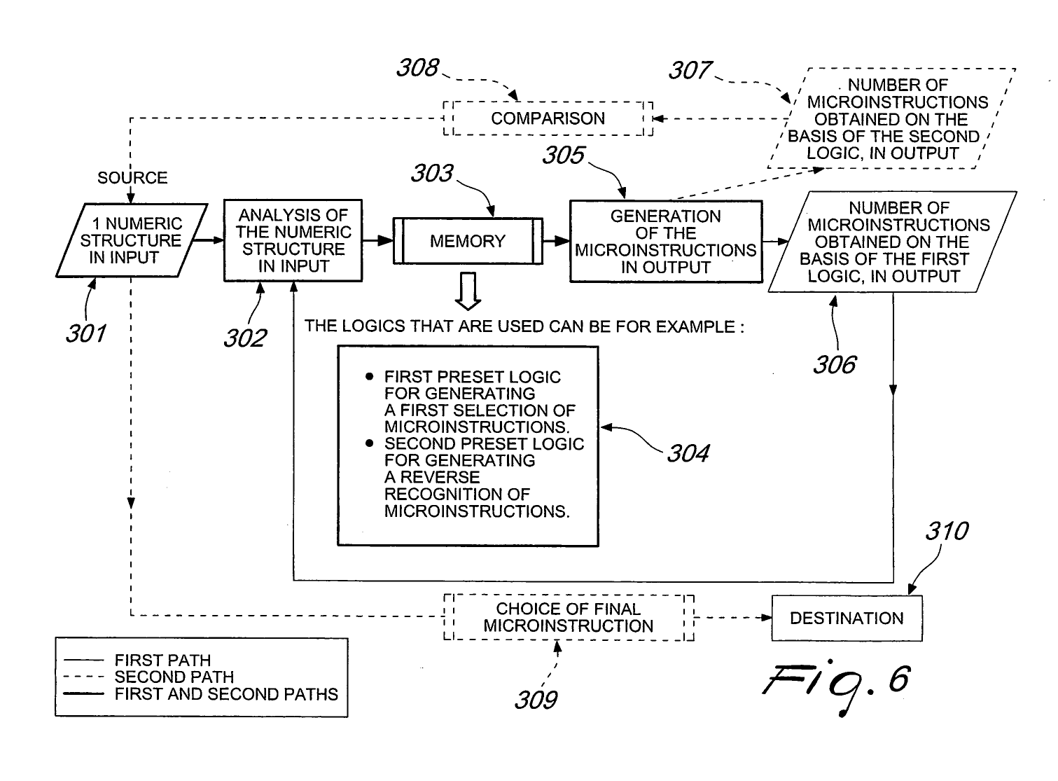

FIG. 6 illustrates an example of a superimposed logic diagram of the new procedure for instruction or microinstruction selection performed by the processing unit, which also shows schematically the apparatus that performs the processing according to the new invention: the numeric structure is input into an input module 301;
the numeric structure is then transferred to an analysis module 302, where it is analyzed and decoded so that it can be interpreted by the memory;
the numeric structure thus analyzed is passed to a memory module 303, which, by using a first preset logic to generate a first selection of microinstructions contained in an internal section 304 thereof, chooses a restricted set of instructions or microinstructions according the reference of the numeric structure in input to the first path, and sends them to a module 105 for generating instructions or microinstructions in output from the first path;

By way of example, it is assumed that the microinstructions generated from a single numeric structure in input are 30, although it is possible to generate a larger or smaller number thereof.
the generation of the microinstructions in output occurs in the module 305, which transfers them, along the first path, to the module 306, which is a module for accumulating and/or sending back the microinstructions obtained on the basis of the first logic;
the module 306 sends the obtained microinstructions to the module 302, which analyzes them and decodes them again so that they can be interpreted by the memory, and sends them to the memory module 303;
the memory module 303, using this time a second preset logic to generate a reverse recognition of microinstructions, contained in an internal section 304 thereof, processes 30 microinstructions, i.e., the same number of microinstructions in input to the reverse path, and sends them to a module 305 for generating instructions or microinstructions in output to the reverse path (or second path);
the generation of the microinstructions in output occurs in the module 305, which transfers them, along the reverse path (or second path), to the module 307, which accumulates them and/or sends them to a module 308, which compares the new 30 microinstructions obtained on the basis of the second logic with the original numeric structure in input in the module 301;
by means of the comparison between the original numeric function and each one of the microinstructions obtained on the basis of the second logic, the microinstruction having a nil or minimum deviation index is chosen and sent to a module 309, which takes the corresponding microinstruction (which therefore has become the final microinstruction), obtained on the basis of the first logic and in output from the module 306, and sends it to the destination 310.

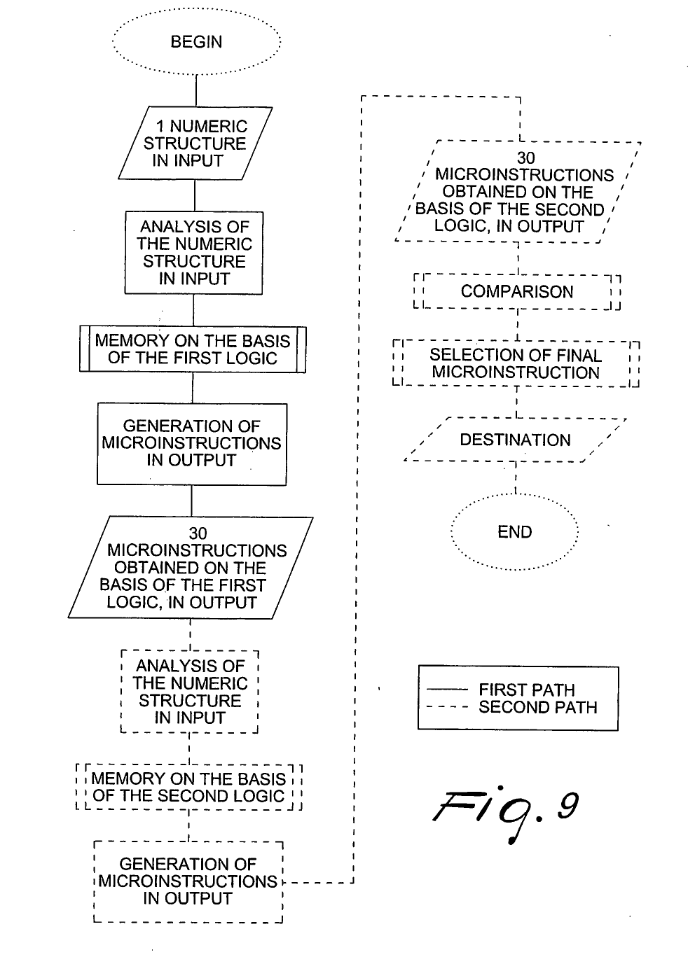

What is described in FIG. 6 is further illustrated also in the examples of diagrams of FIGS. 9, 10 and 11, which assume by way of example that the microinstructions are generated from a single numeric structure in input are 30, although it is possible to generate a larger or smaller number.

As can be seen, it is fundamental to use multiple preset logics, preferably different from each other, in order to obtain, along a first path, a selection of microinstructions in output, and then, along a second path (or reverse path), generate a reverse recognition of microinstructions, with the goal of performing a comparison, the deviation indices of which allow to identify the final microinstruction even in the case of very complex numeric structures in input, which are typical of robotics, automation, artificial intelligence and cybernetics.

The analysis of the numeric structure in input and the generation of the microinstruction in output can also be comprised within the same memory module, in a single module, or located in two or more modules.

The logic or logics used by the memory can be one or more and can be the ones described or other both preset and/or not preset ones.

The system can operate under total automation or with human intervention in one or more points in order to make it to proceed.

The logic or logics used along the first path can be identical to, or different from, the logic or logics used in the second path or in additional paths.

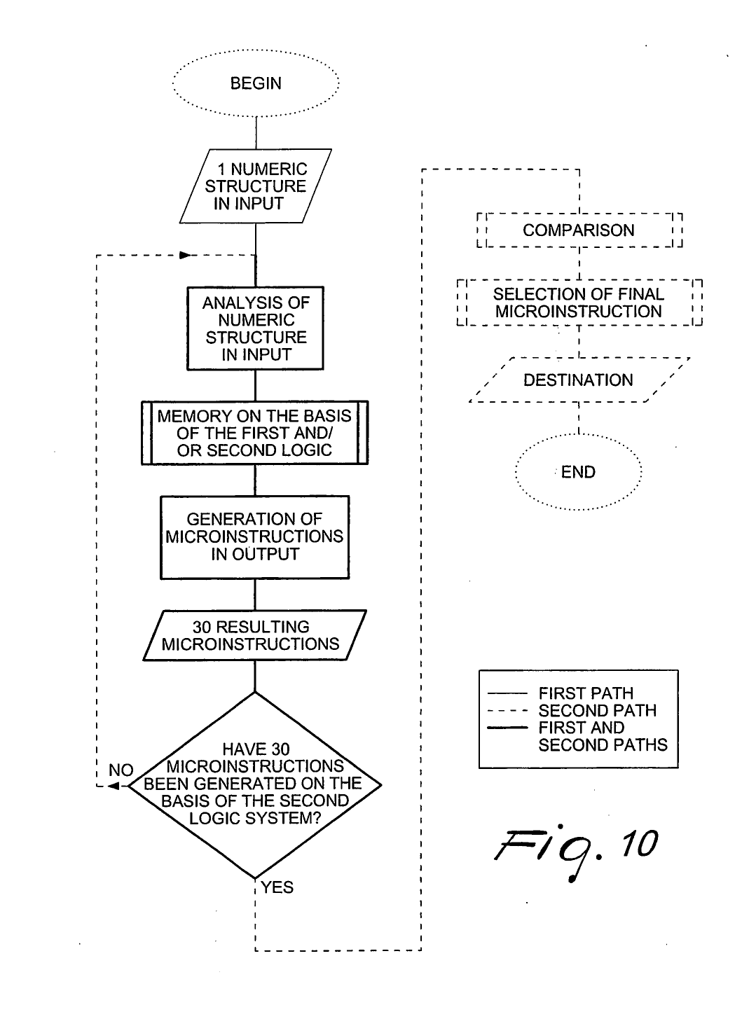

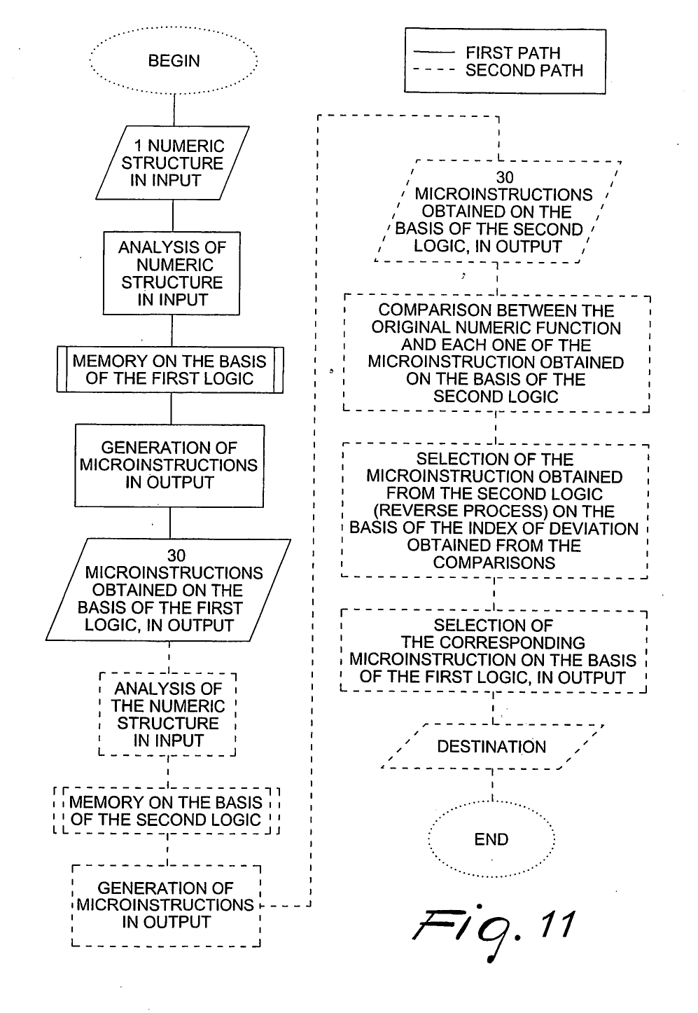

In any case, the logic or logics used can belong to the same memory or to one or more different or identical memories (sequential diagram of FIGS. 9 and 11 and superimposed diagram of FIGS. 6 and 10).

Reverse recognition can be performed by the same memory used along the first path or by another memory or other memories that use the same logic or different logics.

The analysis and/or generation of the numeric structure or of the microinstruction or of the instructions or microinstructions along the various paths can be performed in the memory and/or in the register and/or in other modules.

It is preferable to use, along the first path, a preset logic capable of generating a first selection of instructions or microinstructions.

It is preferable to use, along the second path (or reverse path), a preset logic capable of generating a reverse recognition, i.e., capable of obtaining the same number of microinstructions in input to the second path, with a generation method that allows to obtain the conditions suitable to perform the comparison.

Along the first path, it is also possible to make arrangements to obtain a single output or a single microinstruction in output at a time, until one obtains for example 30 different microinstructions, subsequently performing the reverse path.

The reverse path can be performed all at once (i.e., for all the microinstructions in a single instance) or in multiple instances and can be performed for all the microinstruction that have been obtained or for one or more of them.

The comparison also can be performed all at once (i.e., for all the microinstructions in a single instance) or in multiple instances and can be performed for all the microinstructions or for one or more of them.

It is possible also to consider having multiple systems working simultaneously or at different times, which generate one or more microinstructions and perform the reverse process and the comparison.

The various outputs to the first path can be obtained with the same logic or with multiple different logics, and the same applies for the reverse path (or second path) or optionally for other paths.

The system can be preset, along its various paths, to a number of outputs according to the requirements or have a fixed number of outputs.

A plurality of paths and/or a plurality of path loops can be performed.

Preferably, the reverse path (or second path or return path) yields a single final output, i.e., chooses a single final microinstruction; however, it might choose a plurality of final microinstructions on the basis of the nil, minimum and/or lowest possible deviation indices.

Preferably, the comparison between the original numeric function in input and each one of the microinstruction obtained on the basis of the second logic is performed simply by comparing the various numeric values, as described in the example that follows.

The comparison can occur for the various microinstructions at the same time moment or at different times.

The comparison can also be performed periodically, after accumulating microinstructions, automatically or by means of a manual command.

The comparison between the original numeric function in input and each one of the microinstructions obtained on the basis of the second logic can yield results of two types:
the original numeric function and the microinstruction obtained on the basis of the second logic are perfectly identical, and therefore the deviation index in this case is nil;
the original numeric function and the microinstruction obtained on the basis of the second logic are different. If perfect identity does not occur, the best results the best obtained result or results is/are chosen, i.e., the microinstruction or microinstructions that generated, during the comparison, a minimum variation index is/are chosen.

It is possible to choose from the comparison a single microinstruction or a plurality of microinstructions.

The comparison can be performed several times on the same microinstructions at the same time or at different times, and on microinstructions that have already been compared or not, i.e., in a mixed system, at the same time and at different times.

It is preferable to use a single system for the entire processing; however, it is possible to use a plurality of systems which operate simultaneously or at different times and perform one or more functions in the processing.

Preferably, according to the invention, the method for processing units and the apparatus for performing the method are provided on integrated circuits of the following types:
fuzzy-logic integrated circuits;
CCD digital integrated circuits;
CMOS digital integrated circuits;
DTL digital integrated circuits;
ECL digital integrated circuits;
RTL digital integrated circuits;
TTL digital integrated circuits;
analog linear operational integrated circuits;
analog linear integrated circuits for communications;
analog linear integrated circuits for voltage control;
monolithic integrated circuits;
integrated circuits for computers (CPU);
integrated circuits for automotive electronics;
integrated circuits for telephone modems;
integrated circuits for frequency synthesizers.

In the terminology used:
“numeric structure” is equivalent to “function,” or “numeric function”, or “series of numeric signals”, or “datum or “data”;
“instruction” or “instructions” are equivalent to “microinstruction” or “microinstructions”;
“reverse recognition” is equivalent to “second recognition”;
“reverse path” is equivalent to “second path” or “return path”;
“analysis” or “study” are equivalents;
“generation” or “synthesis” or “development” are equivalents;
“destination” or “target” are equivalents;
“numeric structure” or “function”, or “numeric function” or “datum” or “data” or “instruction” or “instructions” or “microinstruction” or “microinstructions”, are equivalents.

By way of illustration, an example is given in which it is assumed that 30 microinstructions are generated from a single numeric structure in input:

### EXAMPLE

### Sum of Two Numbers

Source: two numeric values in input

| | | |
|---|---|---|
| A | → | 01010101 |
| B | → | 01010111 |

30 microinstructions obtained on the basis of the first logic, in output:

| | |
|---|---|
| 1 | 10101111 |
| 2 | 10101110 |
| 3 | 10100111 |
| 4 | 10101011 |
| 5 | 10100001 |
| 6 | 10100000 |
| 7 | 10101000 |
| 8 | 10101010 |
| 9 | 10101001 |
| 10 | 10100110 |
| 11 | 11111100 |
| 12 | 11101100 |
| 13 | 01111100 |
| 14 | 10111100 |
| 15 | 00011100 |
| 16 | 00001100 |
| 17 | 10001100 |
| 18 | 10101100 |
| 19 | 10011100 |
| 20 | 01101100 |
| 21 | 01111110 |
| 22 | 00011111 |
| 23 | 00001111 |
| 24 | 10101100 |
| 25 | 00000111 |
| 26 | 11101001 |
| 27 | 10111001 |
| 28 | 11111111 |
| 29 | 01111111 |
| 30 | 00111111 |

30 microinstructions obtained on the basis of the second logic system, in output:

| | |
|---|---|
| 1 | 00011100 |
| | 01010111 |
| 2 | 00001100 |
| | 01010111 |
| 3 | 10001100 |
| | 01010111 |
| 4 | 10101100 |
| | 01010111 |
| 5 | 10011100 |
| | 01010111 |
| 6 | 10101111 |
| | 01010111 |
| 7 | 10101110 |
| | 01010111 |
| 8 | 10100111 |
| | 01010111 |
| 9 | 10101011 |
| | 01010111 |
| 10 | 10100001 |
| | 01010111 |
| 11 | 10100000 |
| | 01010111 |
| 12 | 10101000 |
| | 01010111 |
| 13 | 0111100 |
| | 01010111 |
| 14 | 10101001 |
| | 01010111 |
| 15 | 10100110 |
| | 01010111 |
| 16 | 10111100 |
| | 01010111 |
| 17 | 11101001 |
| | 01010111 |
| 18 | 00110111 |
| | 01010111 |
| 19 | 11101100 |
| | 01010111 |
| 20 | 11111100 |
| | 01010111 |
| 21 | 10101010 |
| | 01010111 |
| 22 | 11111111 |
| | 01010111 |
| 23 | 10111001 |
| | 01010111 |
| 24 | 01010101 |
| | 01010111 |
| 25 | 01111111 |
| | 01010111 |
| 26 | 00111111 |
| | 01010111 |
| 27 | 00110011 |
| | 01010111 |
| 28 | 00110001 |
| | 01010111 |
| 29 | 00110101 |
| | 01010111 |
| 30 | 01101100 |
| | 01010111 |

comparison between the original numeric function and each one of the microinstructions obtained on the basis of the second logic;
choice of the microinstruction obtained from the second logic (reverse process) on the basis of the deviation index obtained from the comparisons;
the deviation index is nil for function number 24 obtained by the second logic;
the corresponding numeric function obtained on the basis of the first logic is sent to the destination;
destination→final microinstruction: 1 0 1 0 1 1 0 0.

The advantages of the new system with respect to current systems are: there are no problems as regards the development and calculation of very complex mathematical expressions, thus avoiding problems of system instability and of process slowing;
there are none of the problems that occur in current systems, with complete halting of the entire system, when a large amount of data present on the central unit cannot be processed;
there are no malfunctions of the components of any computerized system, since the unexpected halting of data processing by the processing unit is avoided;
there is the possibility of enormous technical development and there are no limitations for the processing units for very complex functions, such as for example for robotics, for control systems for spacecraft or aircraft, for supercomputers, for servers, for any medium and complex automation system, for artificial intelligence and for cybernetics;
there is an increase in the reliability and speed of processing systems of small and medium complexity, while keeping them compact;
the selection of microinstructions in output from the first path and the subsequent reverse recognition of microinstructions along the second path allow to identify a final microinstruction, which in current processing systems, given a numeric structure in input having low or medium complexity, if performed otherwise, would entail several problems, and which in current processing systems, given a very complex numeric structure in input, if performed otherwise, would be impossible to identify;
speed: by means of the present invention, the number of operations that a processing unit executes is raised to very high values, with a consequent increase in processing speed (a value generally expressed in MHz);
all this of course leads to the provision of very complex processes that are impossible to activate with current systems, with the corresponding consequent possibility for immediate development not only of the hardware peripherals of any computerized system but also of the software structures, which are still at present constantly penalized by the limited speed and reliability of the physical components of the systems;
furthermore, the percentage of “stalled states” will be substantially equal to zero, by way of the extremely high information processing speed, with a consequent increase in the level of reliability;
the multitasking structure that most computer operating systems have is in fact heavily penalized by the poor reactivity of the CPU. This entails the unavoidable general slowing of the entire system, which for example, with an average of only seven active applications, is subject to an evident and severe slowing of any operation, including elementary ones;
production and management costs are in the same range as current processing systems;
the new system therefore allows to obtain operating systems that are much faster and more reliable than current ones and also to obtain application software that is more reactive than current software.

From all of the above it is evident that the intended aim and objects have all been achieved.

Of course, starting from the same inventive concept, the possible embodiments may be different and any convenient components may be used in the apparatus.

The inventive concept can be used and adapted to computers and to any other unit for processing functions and data in any field of use.

The disclosures in Italian Patent Applications No. PD2004A000222 and No. PD2004A000274 from which this application claims priority are incorporated herein by reference.

What is claimed is:

1-22. (canceled)

23. A method for automatic translation from a first language to a second language, comprising the steps of:
g) acquiring an initial sentence or text to be translated;
h) selecting one or more automatic translation techniques;
i) generating a plurality of translations of said initial sentence or text from the first language to the second language by means of said selected translation technique or techniques;
j) for each one of said translations into said second language, generating a back-translation from the second language to the first language;
k) comparing said back-translations into said first language with the initial sentence or text in said first language and generating a corresponding index of deviation;
l) selecting, among said translations into the second language, the translation that corresponds to the back-translation for which the index of deviation is lowest or nil.

24. The automatic translation method of claim 23, wherein said automatic translation techniques are selected from the group that comprises translations preferably of the following types:
direct;
transfer;
interlingua;
knowledge-based;
statistics-based;
example-based;
principle-based;
hybrid approach-based;
example- and statistics-based.

25. The automatic translation method of claim 23, wherein said back-translation from the second language to the first language is performed by using the same translation technique used to translate the sentence or text from the first language to the second language.

26. The automatic translation method of claim 23, wherein said back-translation from the second language to the first language is performed by using a different translation technique with respect to the translation technique used to translate the sentence from the first language to the second language.

27. The automatic translation method of claim 23, wherein said index of deviation is calculated on the basis of one or more types of analysis of the resulting back-translated sentences or texts and of the initial sentence or text, all in the same initial language.

28. The automatic translation method of claim 27, wherein said analysis is selected from the group that comprises preferably:
semantic analysis;
syntactic analysis;
morphological analysis;
interlingua analysis.

29. The automatic translation method of claim 27, wherein said index of deviation is calculated by comparing the initial sentence or text in the first language with each one of the sentences obtained by back-translation into the first language preferably on the basis of one or more of the following elements:
subjects;
verbal predicates;
verb tenses;
objects;
identical resulting words and/or terms;
identical resulting words and/or terms that maintain an identical position in the compared sentences or texts.

30. An automatic apparatus for translation from a first language to a second language, comprising:
means for acquiring an initial sentence or text in a first language;
memory means containing one or more dictionaries for translation from said first language to second language and vice versa;
one or more translators, each preferably based on a different automatic translation architecture and suitable to translate said initial sentence or text into a corresponding translation in the second language and to back-translate said respective translation into a respected back-translation in the first language;
comparison and selection means, for comparing said initial sentence or text and said back-translations, generating a deviation index, and for selecting one or more of said translations in the second language on the basis of said deviation index.

31. The automatic translation apparatus of claim 30, wherein said means for acquiring an initial sentence or text to be translated are selected from the group that comprises preferably:
a text reader;
a magnetic medium;
an optical medium;
a solid-state medium;
a data communications network;
a microphone.

32. The automatic translation apparatus of claim 30, wherein said one or more translators and said comparison and selection means are implemented by way of one or more software programs.

33. The automatic translation apparatus of claim 32, wherein said automatic translation techniques are selected from the group that comprises translations preferably of the following types:
direct;
transfer;
interlingua;
knowledge-based;
statistics-based;
example-based;
principle-based;
hybrid approach-based;
example- and statistics-based.

34. The automatic translation apparatus of claim 30, wherein said back-translation from the second language to the first language is performed by using the same translation technique used to translate the sentence or text from the first language to the second language.

35. The automatic translation apparatus of claim 30, wherein said back-translation from the second language to the first language is performed by using a different translation technique with respect to the translation technique used to translate the sentence from the first language to the second language.

36. The automatic translation apparatus of claim 30, wherein said deviation index is calculated on the basis of one or more types of analysis of the resulting back-translated sentences or texts and of the initial sentence or text, all in the same initial language.

37. The automatic translation apparatus of claim 36, wherein said analysis is selected from the group that preferably comprises:
semantic analysis;
syntactic analysis;
morphological analysis;
interlingua analysis.

38. The automatic translation apparatus of claim 30, wherein said deviation index is calculated by comparing the initial sentence or text in the first language and each one of the sentences obtained by back-translation in the first language preferably on the basis of one or more of the following:
subjects;
verbal predicates;
verb tenses;
objects;
identical resulting words and/or terms;
identical resulting words and/or terms that maintain an identical position in the compared sentences or texts.

39. A method for an integrated-circuit processing unit, comprising the steps of:
a) acquiring a function in input;
b) selecting at least one preset logic for generating instructions (also termed microinstructions);
c) generating a first recognition, i.e., generating at least one instruction of said function by means of at least one selected preset logic;
d) for each one of said obtained instructions, generating a reverse recognition by way of at least one second preset logic;
e) comparing said instructions, reobtained in reverse recognition, with the input function;
f) selecting, among said instructions obtained during first recognition, the instruction corresponding to the instruction obtained during second recognition which, when compared with the input function, generates a nil or minimum deviation index.

40. The method of claim 39, wherein said input function is a numeric structure.

41. The method of claim 39, wherein said input function is a series of numeric signals.

42. The method of claim 39, wherein said input function is a datum or data in input.

43. The method of claim 39, wherein the instructions of said function of item c) are a plurality and increase in value as the complexity of the input function increases.

44. An apparatus performing a method for an integrated-circuit processing unit, comprising:
means for acquiring a numeric structure or function or a series of numeric signals or a datum or data in input;
means for selecting one or more preset logics for generating instructions or microinstructions;
means for generating a first recognition, i.e., for generating one or more instructions or microinstructions of said numeric structure or function or of said series of numeric signals or of said datum or data in input by means of one or more selected preset logics;
means for generating, for each one of said resulting instructions or microinstructions, a reverse recognition by means of one or more different preset logics;
means for comparing said instructions or microinstructions, reobtained in reverse recognition, with the numeric structure or function in input or with the series of numeric signals in input or with the datum or data in input;
means for selecting, among said instructions or microinstructions obtained during first recognition, the instruction corresponding to the instruction obtained during second recognition which, when compared with the numeric structure or function in input or with the series of numeric signals or with the datum or data in input, generates a nil or minimum variation index.
